(19) United States
(12) Patent Application Publication
(10) Pub. No.: US 2014/0308849 A1
(43) Pub. Date: Oct. 16, 2014

(54) ELECTRICAL CONNECTOR HAVING A STRUCTURE FOR AVOIDING HIGH VOLTAGE CONDUCTION

(71) Applicant: HON HAI PRECISION INDUSTRY CO., LTD., New Taipei (TW)

(72) Inventors: CHIH-CHING HSU, New Taipei (TW); ZHI-HUI TANG, Kunshan (CN); ZHI-CHENG ZHANG, Kunshan (CN); XIAO-DONG YANG, Kunshan (CN)

(73) Assignee: HON HAI PRECISION INDUSTRY CO., LTD., New Taipei (TW)

(21) Appl. No.: 14/253,011

(22) Filed: Apr. 15, 2014

(30) Foreign Application Priority Data
Apr. 15, 2013 (CN) 2013101303331
Jun. 5, 2013 (CN) 2013102196981
Jun. 5, 2013 (CN) 2013102197005

(51) Int. Cl. H01R 13/6581

(52) U.S. Cl. CPC H01R 13/6581
USPC 439/607.55

(57) ABSTRACT

An electrical connector includes an insulative housing, a printed circuit board, a set of mating contacts, and a shielding shell. The insulative housing defines a mating port for insertion of a plug connector and a mounting port for installing the printed circuit board. The insulative housing includes a lower wall for mounting to an exterior substrate and an upper wall. The printed circuit board is disposed behind the upper wall. The set of mating contacts each has a contact portion exposed to the mating port and a first connection portion connected to the printed circuit board. The shielding shell has a top wall surrounding the upper wall of the insulative housing. The top wall of the shielding has a cutout or a protrusion located above the first connecting portions for avoiding the first connecting portions electrically conducting to the top wall.

### BACKGROUND OF THE INVENTION

1. Field of the Invention

The present invention relates to an electrical connector having contacts and a shielding shell, specially relates to a structure for avoiding high voltage conduction between the contacts and the shielding shell.

2. Description of Related Art

An electrical connector of a prior art design as shown in FIG. 1 has an insulative housing 1, a PCB (printed circuit board) 2, a set of mating contacts, and a shielding shell 5. The insulative housing 1 defines a mating port for inserting a plug connector and a mounting port for installing the PCB 2. The insulative housing 1 includes a lower wall for mounting to an exterior substrate and an upper wall. The PCB is disposed behind the upper wall and is not enclosed by the upper wall. The set of mating contacts each has a contact portion exposed to the mating port and a first connection portion connected to the PCB 2. The shielding shell has a top wall surrounding the upper wall of the insulative housing. The electrical connector has an insulative rubber tape 7 disposed between the first connecting portion and the shielding shell for avoiding high voltage conduction therebetween. It is time-consuming for assembling the insulative rubber tape 7 to the insulative housing and, moreover, the insulative rubber tape 7 may fall off.

An electrical connector having a simple structure is desired.

### SUMMARY OF THE INVENTION

Accordingly, an object of the present invention is to provide an electrical connector having a simple structure for avoiding high voltage conduction.

In order to achieve the object set forth, the invention provides an electrical connector including an insulative housing, a PCB, a set of mating contacts, and a shielding shell. The insulative housing defines a mating port for insertion of a plug connector and a mounting port for installation of the PCB. The insulative housing includes a lower wall for mounting to an exterior substrate and an upper wall. The PCB is disposed behind the upper wall. The set of mating contacts each have a contact portion exposed to the mating port and a first connection portion connected to the PCB. The shielding shell encloses the insulative housing and the PCB. The shielding shell has a top wall surrounding the upper wall of the insulative housing. The top wall of the shielding has a cutout or a protrusion located above the first connecting portions for avoiding the first connecting portions from electrically conducting to the top wall.

Other objects, advantages and novel features of the invention will become more apparent from the following detailed description when taken in conjunction with the accompanying drawings.

### BRIEF DESCRIPTION OF THE DRAWINGS

FIG. 1 is an exploded view of an electrical connector of a prior art;

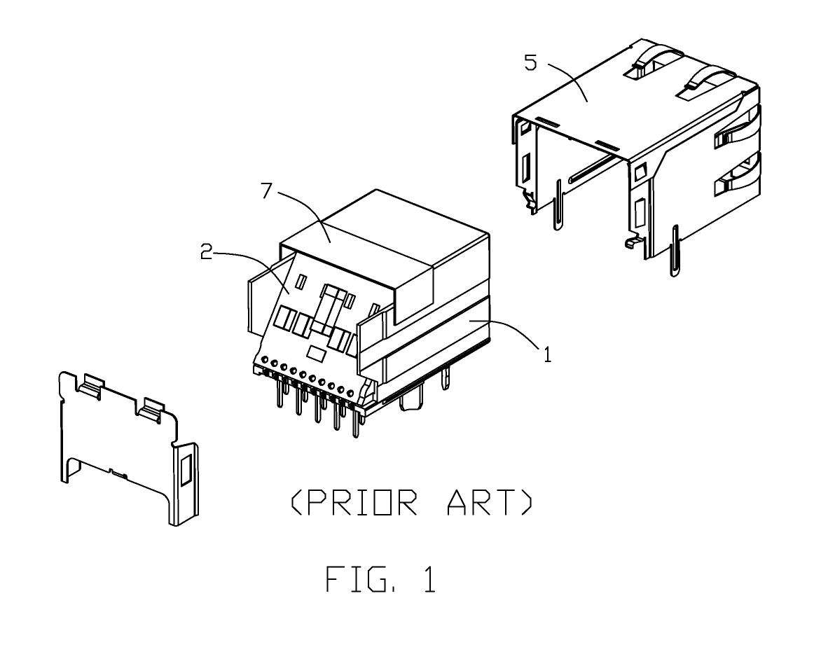

FIG. 2 is a perspective view of a first embodiment of an electrical connector;

FIG. 3 is an exploded view of the electrical connector shown in FIG. 2;

FIG. 4 is a further exploded view of the electrical connector shown in FIG. 3;

FIG. 5 is another exploded view of the electrical connector shown in FIG. 4;

FIG. 6 is a top view of the electrical connector seen in FIG. 2;

FIG. 7 is perspective view of a second embodiment of the electrical connector;

FIG. 8 is an exploded view of the electrical connector seen in FIG. 7; and

FIG. 9 is a cross-sectional view of the electrical connector seen in FIG. 7, taken along line 9-9.

### DETAILED DESCRIPTION OF THE PREFERRED EMBODIMENT

Reference will now be made in detail to the preferred embodiment of the present invention.

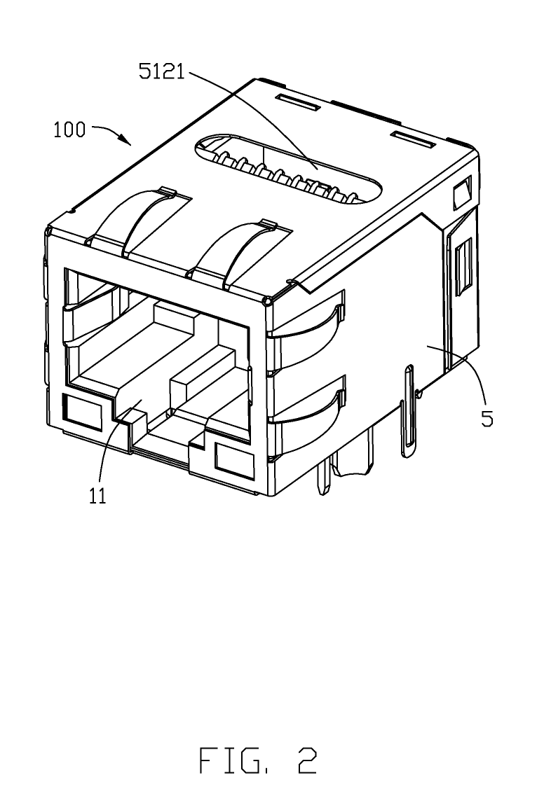

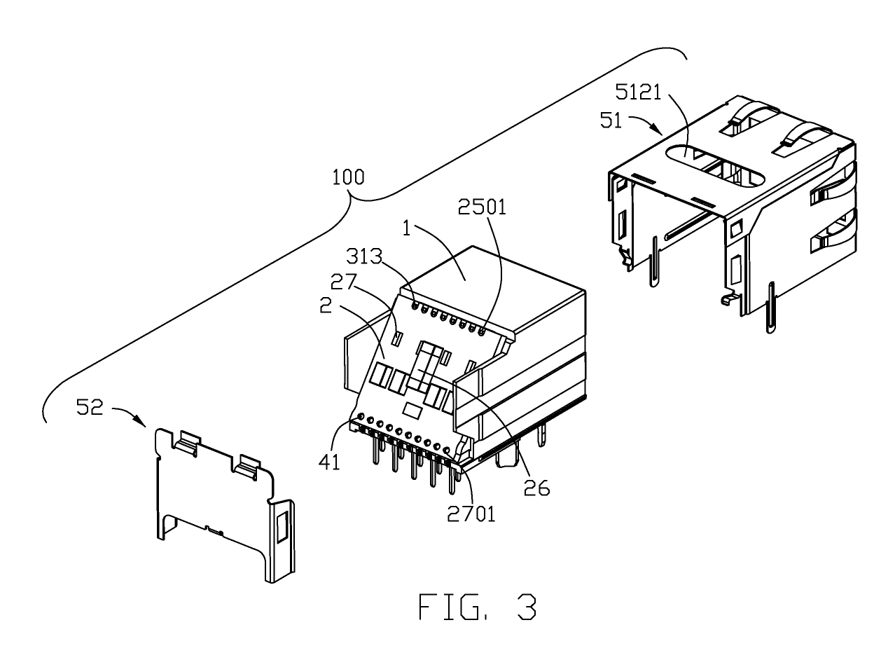

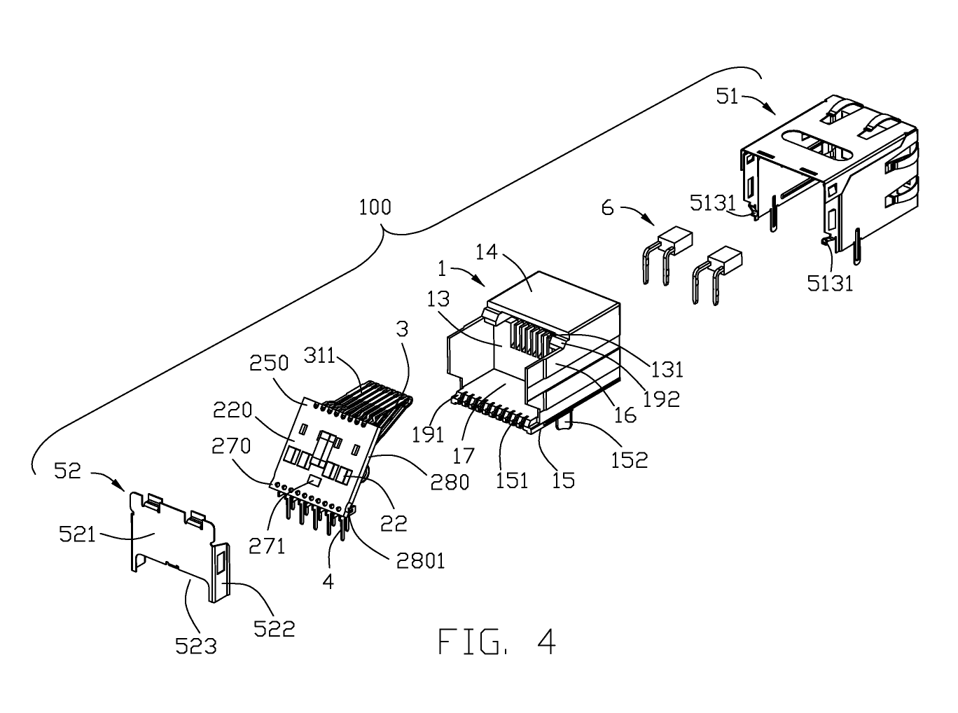

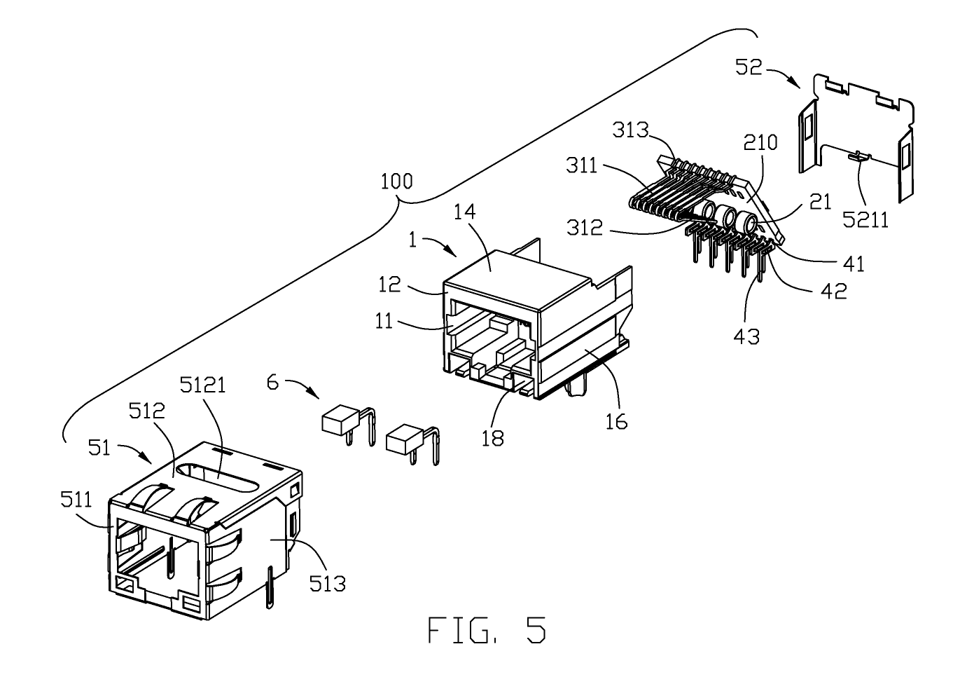

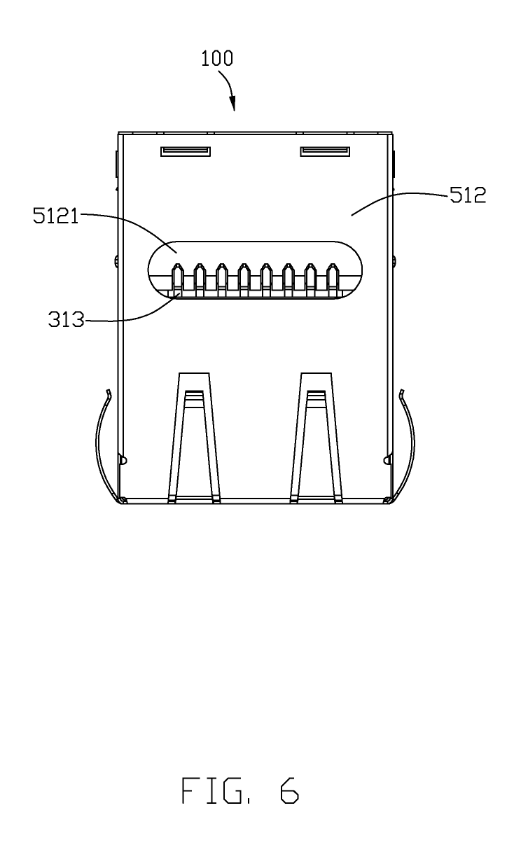

Referring to FIGS. 2-6, an electrical connector 100 (modular jack) of a first embodiment is shown. The electrical connector 100 could be mounted on an exterior substrate (not shown) and mated with a modular plug (not shown). The electrical connector 100 has an insulative housing 1, a PCB (printed circuit board) 2, a set of mating contacts 3, a set of mounting contacts 4, and a shielding shell 5.

The insulative housing 1 has a front wall 12 extending vertically along a transverse direction, a rear wall 13, an upper wall 14 extending horizontally along a front-to-back direction, a lower wall 15 for mounting to the exterior substrate, and a pair of side walls 16 extending vertically along the front-to-back direction. The insulative housing 1 defines a mating port 11 for receiving one modular plug and a mounting port 13 disposed behind the mating port 11. The mating port 11 is recessed from the front wall 12 along the front-to-back direction. The mounting port 17 connects with the mating ports 15 through a row of spaced grooves 131. The mounting port 17 is surrounded by the rear wall 13, the lower wall 15 and the side walls 16. The upper wall 14 extends from a top section of the rear wall 13 along a back-to-front direction. The electrical connector 100 includes two LEDs (Light Emitting Diodes) 6 for indicating communication status of the electrical connector 100. The inslulative housing 1 defines two mounting passageway 18 under the mating port 11 for installing the LEDs 6 thereinto respectively.

The lower wall 15 defines a row of fastening slots 151 for retaining the mounting contacts 4 respectively. The fastening slots 151 are disposed at a rear edge of the lower wall 15. The lower wall 15 has a mounting post 152 extending downwardly for inserting to the exterior substrate. The inslulative housing 1 has two first inclined platforms 191 laterally positioned at two opposite sides of the row of fastening slots 151. The inslulative housing 1 also has two second inclined platforms 192 laterally positioned at two opposite sides of the row of spaced grooves 131.

The PCB 2 is mounted into the mounting port 13. The PCB 2 has a plurality of electronic components mounted thereon. The PCB 2 has an upper portion 250 and a lower portion 270. The PCB 2 is disposed in the mounting port 13 in an oblique manner under condition that the upper portion 250 of the PCB 2 is disposed in front of the lower portion 270. The upper portion 250 is supported by the second inclined platforms 192. The lower portion 270 is supported by the first inclined platforms 191. The PCB 2 has a first surface 210 facing toward to the mating port 11 and a second surface 220 facing opposite to the first surface 210. The electronic components includes a plurality of isolated transformers 21 disposed on the first surface 210 and a plurality of common mode choke 22 disposed on the second surface 220. The electronic components also includes a capacitor 26 and four resistors 27 disposed on the second surface 220. Each isolated transformer 21 has a torrid core and a plurality of coils (not shown) wrapped thereon. The PCB 2 has two side edges 280 each defining a conductive groove 2801 recessed therefrom. The conductive grooves 2801 are disposed at the lower portion 270 of the PCB 2. The PCB 2 has a grounding pad 271 disposed on the lower portion 270.

Each mating terminal 3 has a contact portion 312 exposed to the mating port 11, a horizontal portion 311 displaced adjacent to the upper wall 14 and a first connecting portion 313 connected to the upper portion 250 of the PCB 2. The contact portion 312 extends downwardly and backwardly from the horizontal portion 312 in the mating port 11. The horizontal portion 311 extends along the front-to-back direction. The first connecting portion 313 extends upwardly and backwardly from the horizontal portion 311 and is not shielded by the upper wall 14. The first connecting portion 313 extends perpendicular to the PCB 2. The PCB 2 defines a row of notches 2501 positioned at the upper portion 250 for the first connecting portions 313 of the mating terminals 3 inserting thereinto respectively.

Each mounting contact 4 has a mounting portion 43 for mounting onto the exterior substrate, a retention portion 42 fixed by the bottom wall 12 of the inslulative housing 1 and a second connecting portion 41 connected with a lower portion 270 of the PCB 2. The mounting portion 43 extends downwardly beyond the lower wall 15. The retention portion 42 extends along the front-to-back direction. The second connecting portion 41 extends upwardly and backwardly from the retention portion 42. The second connecting portion 41 extends perpendicular to the PCB 2. The PCB 2 defines a row of holes 2701 positioned at the lower portion 270 for the second connecting portions 41 inserting thereinto respectively. The retention portion 42 is received in the fastening slots 151. The retention portion 42 has a barb (not labeled) extending along the front-to-back direction and hold by the fastening slots 151.

The shielding shell 5 includes a front shell 51 and a rear shell 52. The front shell 51 is assembled together with the rear shell 52 for enclosing the inslulative housing 1 and PCB 2. The front shell 51 has a front wall 511, a top wall 512 and two side walls 513 surrounding the front wall 12, the upper wall 14 and the side walls 16 of the insulative housing 1 respectively. The top wall 512 has a cutout 5121 located above the first connecting portions 313 of the mating contacts 3. The cutout 5121 is provided for avoiding the first connecting portion 313 electrically conducting to the top wall 512 of the front shell 51 under high voltage transmitted through the mating contacts 31 from the modular plug. The rear shell 52 has a rear wall 521 and two mating wall 522 extending from two opposite sides of the rear wall 521. The rear wall 521 defines an opening 523 located behind the second connecting portion 41 of the mounting contacts 4 for avoiding the second connecting portion 41 contacting with the rear wall 521. The rear shell 52 has a lower tap 5211 protruded forwardly from a bottom portion of the rear wall 521 and connected with the grounding pad 271 of the PCB 2. The front shell 51 has two side taps 5131 each protruded toward the PCB 2 for connecting with the conductive grooves 2801 respectively.

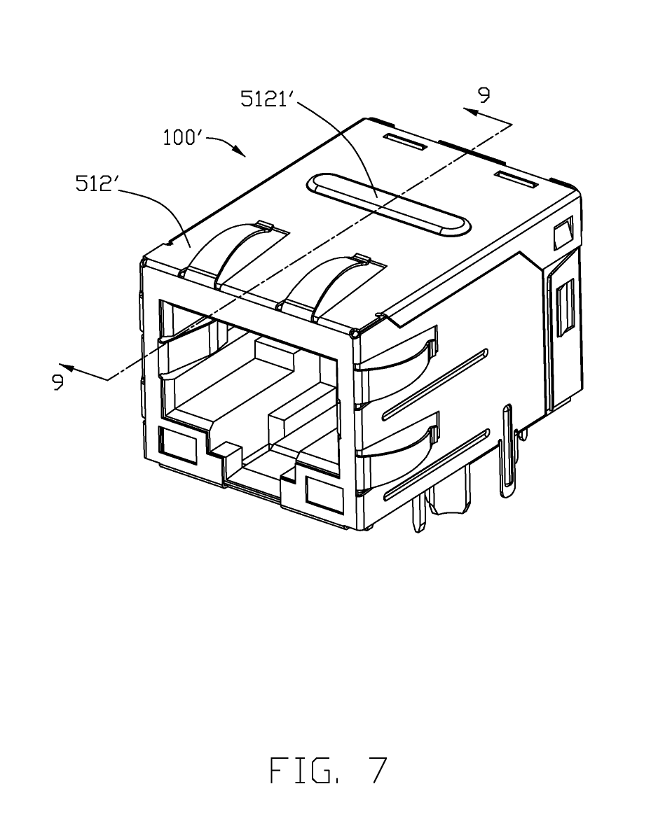

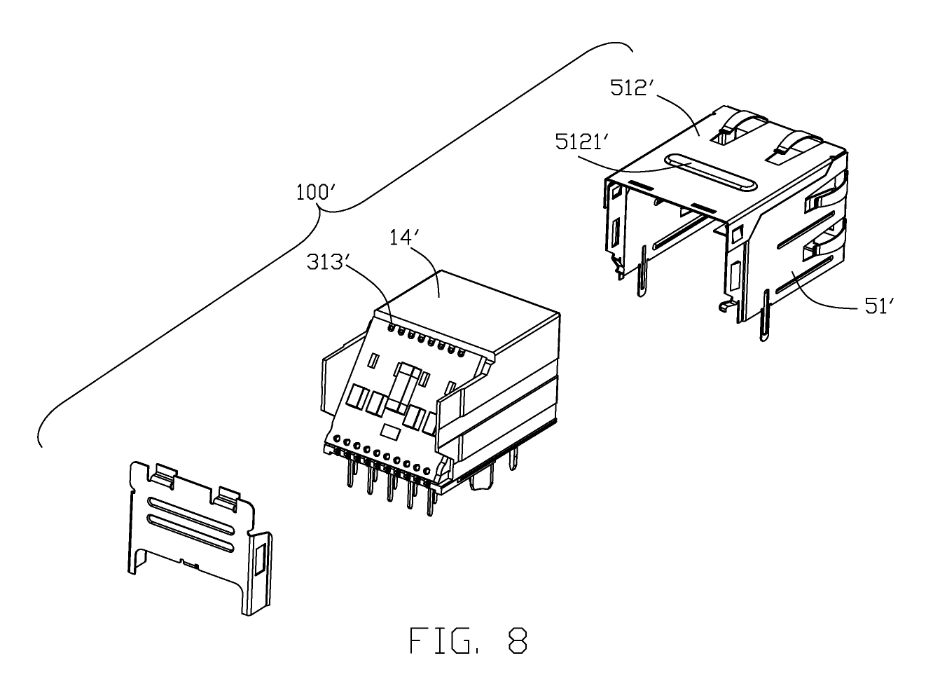

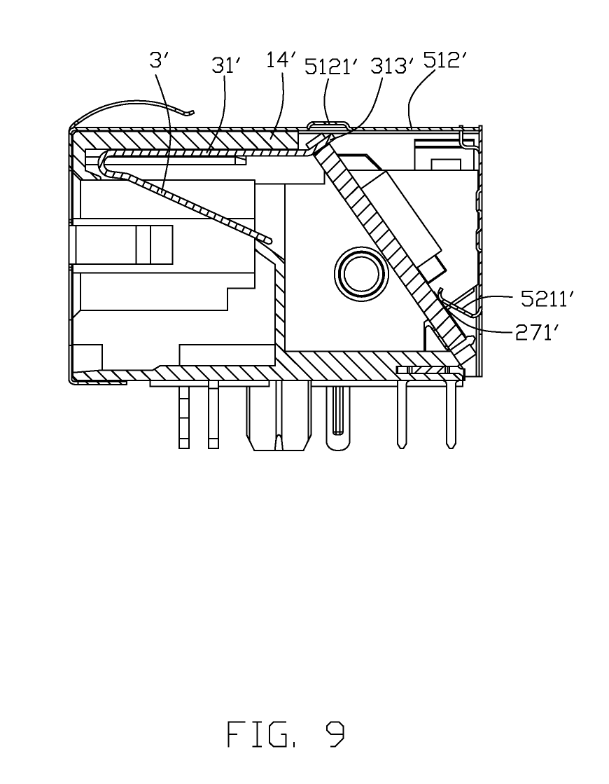

Referring to FIGS. 7-9, an electrical connector 100′ according to a second embodiment of the invention is different from the electrical connector 100 only in that the cutout 5121 is replaced to a protrusion 5121′ protruded upwardly from a top wall 512′ of a front shell 51′ for far away from the first connecting portions 313′ of mating contacts 3′. The protrusion 5121′ is provided for increasing distance between the first connecting portions 313′ and the top wall 512′ of the front shell 51′ and avoiding the first connecting portions 313′ electrically conducting to the top wall 512′. The lower tap 5211′ is connected to the grounding pad 271′. The upper wall 14′ of the insulative housing 1′ does not enclose the first connecting portions 313′.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. An electrical connector comprising:
an insulative housing defining a mating port and a mounting port, the insulative housing including a lower wall for mounting to an exterior substrate and an upper wall;
a printed circuit board installed into the mounting port and located behind the upper wall;
a set of mating contacts each having a contact portion exposed to the mating port and a first connection portion connected to the printed circuit board; and
a shielding shell enclosing the insulative housing and the printed circuit board, the shielding shell having a top wall surrounding the upper wall of the insulative housing; wherein
the top wall of the shielding has a cutout located above the first connecting portions of the mating contacts.

2. The electrical connector as claimed in claim 1, wherein the printed circuit board has an upper portion and a lower portion, the printed circuit board disposed in the mounting port in an oblique manner under condition that the upper portion is disposed in front of the lower portion.

3. The electrical connector as claimed in claim 2, further including a set of mounting contacts each having a mounting portion for mounting to the exterior substrate.

4. The electrical connector as claimed in claim 3, wherein each mounting contact has a second connecting portion connected with the lower portion of the printed circuit board, the first connecting portion connecting with the upper portion of the printed circuit board.

5. The electrical connector as claimed in claim 4, wherein the shielding shell includes a front shell and a rear shell assembled with each other, the front shell having the top wall with the cutout, the rear shell having a rear wall defining an opening located behind the second connecting portion.

6. The electrical connector as claimed in claim 5, wherein the rear shell has a lower tap protruded forwardly from a bottom section of the rear wall and connected with the lower portion of the printed circuit board.

7. The electrical connector as claimed in claim 6, wherein the printed circuit board has two side edges each defining a conductive groove, the front shell having two side taps each protruded toward the printed circuit board for connecting with the conductive grooves respectively.

8. An electrical connector comprising:
an insulative housing defining a mating port and a mounting port, the insulative housing including a bottom wall for mounting to an exterior substrate and an upper wall;
a printed circuit board installed into the mounting port and located behind the upper wall;
a set of mating contacts each having a contact portion exposed to the mating port and a first connection portion connected to the printed circuit board; and
a shielding shell enclosing the insulative housing and the printed circuit board, the shielding shell having a top wall surrounding the upper wall of the insulative housing; wherein
the shielding shell has a protrusion protruded upwardly away from the first connecting portions.

9. The electrical connector as claimed in claim 8, wherein the printed circuit board has an upper portion and a lower portion, the printed circuit board disposed in the mounting port in an oblique manner under condition that the upper portion is disposed in front of the lower portion.

10. The electrical connector as claimed in claim 9, further including a set of mounting contacts each having a mounting portion for mounting to the exterior substrate.

11. The electrical connector as claimed in claim 10, wherein each mounting contact has a second connecting portion connected with the lower portion of the printed circuit board, the first connecting portion connecting with the upper portion of the printed circuit board.

12. The electrical connector as claimed in claim 11, wherein the shielding shell includes a front shell and a rear shell assembled with each other, the front shell having a top wall with the protrusion located above the first connecting portion, the rear shell having a rear wall defining an opening located behind the second connecting portion.

13. The electrical connector as claimed in claim 12, wherein the rear shell has a lower tap protruded forwardly from a bottom portion of the rear wall and connected with the lower portion of the printed circuit board.

14. The electrical connector as claimed in claim 13, wherein the printed circuit board has two side edges each defining a conductive groove, the front shell having two side taps each protruded toward the printed circuit board for connecting with the conductive grooves respectively.

15. An electrical connector comprising:
an insulative housing including a middle wall to divide opposite front mating port and rear mounting port in a front-to-back direction, and opposite top and bottom wall and opposite lateral side walls commonly surrounding the front mating port;
a plurality of mating contacts disposed in the housing, each of said mating contacts defining a front contacting section exposed in the mating port and a rear tail section extending through the middle wall into the mounting port;
a printed circuit board disposed in the mounting port in an oblique manner in a side view, an upper edge region of the printed circuit board positioned close to the middle wall and far away from a bottom face of the housing to mechanically and electrically connect to the tail sections of the corresponding mating contacts while a lower edge region of the printed circuit board is positioned close the bottom face of the housing and far away from the middle wall to mechanically and electrically connect to a plurality of mounting contacts around the bottom face of the housing; and
a metallic shell enclosing the housing and defining a top plate covering the top wall of the housing, a pair of side plates covering the corresponding lateral side walls of the housing respectively, and a rear plate covering a rear side of the housing; wherein
the top wall is terminated around the upper edge region of the printed circuit board while the top plate of the shell extends rearward beyond a rear end of the top wall and is terminated around the rear side of the housing; wherein
the top plate of the shell forms therein a space in a horizontal plane defined by said top plate, corresponding to the upper edge region of the printed circuit board to not improperly interact with the tail sections of the mating contacts thereabouts.

16. The electrical connector as claimed in claim 15, wherein the space spans in a transverse direction to comply with the mating contacts in said transverse direction.

17. The electrical connector as claimed in claim 15, wherein the said space is upwardly shielded by a protrusion which is unitarily raised up with the top plate.

18. The electrical connector as claimed in claim 15, wherein said rear plate is discrete from remainders of the shell.

19. The electrical connector as claimed in claim 15, wherein a rear tip region of the tail section of each of the mating contacts extends upwardly in the oblique manner to extend through the printed circuit board in a perpendicular manner.

20. The electrical connector as claimed in claim 15, wherein the rear plate of the shell forms a resilient tap abutting against the printed circuit board to not only electrically ground to the printed circuit board but also mechanically apply a downward force upon the printed circuit board.
